(19) United States
(12) Patent Application Publication
(10) Pub. No.: US 2007/0217202 A1
(43) Pub. Date: Sep. 20, 2007

(54) Spread illuminating apparatus

(75) Inventor: Makoto Sato, Kitasaku-gun (JP)

Correspondence Address: OLIFF & BERRIDGE, PLC, P.O. BOX 19928, ALEXANDRIA, VA, 22320, US

(73) Assignee: MINEBEA CO., LTD., Kitasaku-Gun (JP)

(21) Appl. No.: 11/699,553

(22) Filed: Jan. 30, 2007

(30) Foreign Application Priority Data
Mar. 14, 2006 (JP) 2006-069209

(51) Int. Cl. F21V 29/00

(52) U.S. Cl. 362/294

(57) ABSTRACT

A spread illuminating apparatus includes: a light conductor plate; at least one LED disposed at a side surface of the light conductor plate; an FPC including a substrate and first and second conductive patterns formed respectively at the front ad rear surfaces of the substrate; and a heat radiating plate to hold the FPC. The LED is mounted on electrode pads formed at the first conductive pattern of the FPC, and all the side faces of the LED are covered with an individual thermal conductor enclosure which is connected to the second conductive pattern via an opening formed at the substrate of the FPC. Thus, a heat radiation system is established from the side faces of the LED through to the heat radiating plate which is affixed to the rear surface of the FPC.

### BACKGROUND OF THE INVENTION

1. Field of the Invention

The present invention relates to a side light type spread illuminating apparatus, and particularly to a spread illuminating apparatus for use as a lighting means for a crystal liquid display device.

2. Description of the Related Art

A side light type spread illuminating apparatus, in which a primary light source is disposed at a side surface of a light conductor plate, is predominately used as a lighting means for a liquid crystal display (LCD) device used in a mobile telephone, and the like. Conventionally, the primary light source has been constituted by a cold cathode lamp. Currently, a point light source, such as a white light emitting diode (LED), which is easier to handle, enables easier downsizing, and which is more resistant to impact shock than the cold cathode lamp, is heavily used. The application of a spread illuminating apparatus using such a point light source is expanding beyond usage in a small LCD device for a mobile telephone, and is now considered for usage in a relatively large LCD device for a car navigation system.

In order to satisfactorily cover an increased illumination area in a larger LCD device, it is desirable to apply an increased current to the point light source thereby increasing the amount of light emitted from the point light source. The increased current applied to the point light source, however, causes an increase of heat thus raising temperature, which lowers the luminous efficiency of the point light source.

To overcome such a problem, various methods are considered to efficiently allow heat generated by the point light source to escape outside. For example, a spread illuminating apparatus 1 shown in FIG. 8 includes a light conductor plate 2, LEDs 3 as point light sources mounted on a flexible printed circuit board (hereinafter, referred to as FPC as appropriate) 4 and disposed at a side surface 2a of the light conductor plate 2, and a frame 5 to hold together the components described above, wherein the frame 5 is made of a metallic material, such as aluminum, having an excellent heat conductance. Specifically, in the spread illuminating apparatus 1 shown in FIG. 8, the light conductor plate 2 is mounted on a floor portion 5b of the frame 5, and the FPC 4 has its rear surface fixedly attached to a wall portion 5a of the frame 5, whereby heats emitted from the LEDs 3 are adapted to be efficiently released from the frame 5 functioning as a heat sink (hereinafter, the frame is referred to as heat radiating plate as appropriate).

Referring now to FIG. 9, a material having an excellent heat conductance is set in a direct contact with side faces of a point light source (refer to, for example, Japanese Patent Application Laid-Open No. 2004-186004, FIG. 2 and paragraph [0037]). Specifically, an LCD device 100 shown in FIG. 9 generally includes LCD elements 110, and a spread illuminating apparatus 120 disposed behind the LCD elements 110. The spread illuminating apparatus 120 includes LEDs 121 mounted on an FPC 124, a light conductor plate 122, and a chassis 123 made of a metallic material. The chassis 123 is disposed so as to make a direct contact with a rear face 121b of each LED 121 opposite to a front face (light emitting face) 121a thereof, and with a bottom face 121c thereof, whereby heats emitted from the LEDs 121 are transferred to the metallic chassis 123.

In the structure shown in FIG. 9, however, the chassis 123 does not make contact with a side face 121d and a side surface (not shown) opposite to the side face 121d, and is just exposed to an air. In this regard, the aforementioned Japanese Patent Application Laid-Open No. 2004-186004 states that the chassis 123 may make contact with other faces of the LED 121 than the rear and the bottom faces 121b and 121c of the LED 121, but the specific structure is not disclosed.

The structure shown in FIG. 9, with lack of a direct heat radiating area, fails to provide a heat radiation system good enough to efficiently release heats generated at point light sources such as LEDs. Especially, when a large current is applied to the LEDs, heat radiation amount from the LEDs is caused to increase, thus making the problem prominent. An alternative method to efficiently release the heats generated at the LEDs may be constituted by use of a metallic board of aluminum or copper, but such a metallic board gives restrictions to designing of wirings, patterns, and outer configurations, and also makes it difficult to reduce the height of the spread illuminating apparatus.

### SUMMARY OF THE INVENTION

The present invention has been made in light of the above problems, and it is an object of the present invention to provide a spread illuminating apparatus, in which a conductive pattern of an FPC is effectively utilized as a part of a heat radiation system, whereby heats emitted from point light sources are efficiently released from the surfaces of the FPC.

In order to achieve the object described above, according to an aspect of the present invention, there is provided a spread illuminating apparatus which includes: a light conductor plate; at least one point light source disposed at a side surface of the light conductor plate; an FPC including a conductive pattern and having the at least one point light source mounted thereon; and a heat radiating plate to hold the FPC. In the spread illuminating apparatus described above, each point light source has its side faces covered by a thermal conductor enclosure which is connected to the conductive pattern of the FPC.

Since each point light source has its side faces covered by the thermal conductor enclosure connected to the conductive pattern of the FPC, a heat radiation system can be established in which heats emitted from the side faces of the point light source are conducted through the thermal conductor enclosure and the conductive pattern of the FPC, and then to the heat radiating plate held by the FPC. Thus, the heats emitted from the point light source can be efficiently conducted to the heat radiating plate thereby improving the heat radiation performance. Also, even in case of providing a plurality of point light sources, since each point light sources is covered by an individual thermal conductor enclosure, all the side faces of the point light source can be easily covered regardless of how the point light sources are arranged, thus providing preferable conditions for improving the heat radiation performance. And, since the conductive pattern of the FPC is effectively utilized as a part of the thermal pathway, the heat radiation performance can be improved by use of conventional FPCs.

In the aspect of the present invention, the FPC may further include a substrate, with the conductive pattern being composed of first and second conductive patterns formed respectively at the front and rear surfaces of the substrate; the point light source may be mounted on a pair of electrode pads formed at the first conductive pattern; the FPC may have its rear surface affixed to the heat radiating plate; and a heat radiation system from the thermal conductor enclosure to the heat radiating plate may contain a thermal pathway which connects between the thermal conductor enclosure and the second conductive pattern without the substrate intervening therebetween. Thus, the dual conductive pattern structure of the FPC is effectively utilized as a part of the thermal pathway, and the heats emitted from the point light source can be better radiated.

In the aspect of the present invention, the FPC may include an opening at the front surface thereof so as to expose a part of the second conductive pattern, and the thermal pathway is formed such that the thermal conductor enclosure is connected to the part of the second conductive pattern exposed from the opening. With this structure, the thermal conductor enclosure and the second conductive pattern can be connected to each other directly by a thermal pathway having a relatively small length and a large section area (consequently, rendering a low resistance), thereby further enhancing the heat radiation.

In the aspect of the present invention, the thermal conductor enclosure may be connected to a thermal pad formed at the first conductive pattern, and the thermal pathway may be formed such that a throughhole communicating with the second conductive pattern is formed at the thermal pad. In this structure, the throughhole enables the thermal pathway to connect between the thermal conductor enclosure and the second conductive pattern directly without the substrate intervening therebetween, and the thermal pads for connection with the thermal conductor enclosure are formed at the first conductive pattern at which the electrode patterns for mounting the point light source are formed, whereby the thermal conductor enclosure can be connected to the conductive pattern easily.

In the aspect of the present invention, the thermal conductor enclosure may include two separate members opposing each other with an air gap therebetween. In this case, the two separate members of the thermal conductor enclosure may be connected respectively to the pair of electrode pads having each point light source mounted thereon. Since the thermal conductor enclosure composed of two separate members can be brought into a closer and tighter contact with the side faces of the point light source when mounted on the FPC while the two separate members can be electrically insulated from each other surely by the air gap formed therebetween, each of the electrode pads for the point light source and each of the thermal pad for the thermal conductor enclosure can be formed integrally into one single structure, whereby the FPC can be structured simple, and the wiring space of the FPC can be saved.

In the aspect of the present invention, the thermal conductor enclosure may be made of a copper material and connected to the conductive patter by soldering. In this case, the thermal conductor enclosure may be connected to the conductive pattern when the point light source is mounted on the FPC. Brass as an example of copper material is high in thermal conductance, low in cost, and good in workability, and therefore is a suitable material for a thermal conductor enclosure of the present invention. Also, the thermal conductor enclosure made of brass can be suitably connected to the conductive pattern by soldering, which enables the thermal conductor enclosure to be duly connected to the conductive pattern at the same time the point light source is mounted on the FPC, whereby a good assembling workability can be established. And, since the thermal conductor enclosure is connected to the conductive pattern via solder layer having a high thermal conductance, the heat radiation performance can be enhanced.

Accordingly, the present invention provides a spread illuminating apparatus, in which the conductive pattern of the FPC is effectively used as a part of the thermal pathway, and the heat emitted from the point light source can be efficiently released from the side surface. Consequently, the spread illuminating apparatus can emit light with a higher intensity while its dimension and profile are kept small. The heat radiation system or structure established in the spread illuminating apparatus according to the present invention can be preferably used, especially, in a spread illuminating apparatus incorporating an LED to which a large current is applied.

### BRIEF DESCRIPTION OF THE DRAWINGS

FIGS. 1A, 1B and 1C are top plan views of a relevant portion of an FPC included in a spread illuminating apparatus according to a first embodiment of the present invention, wherein FIG. 1A shows the FPC with LEDs and thermal conductor enclosures mounted thereon, FIG. 1B shows the FPC with no components mounted thereon, and FIG. 1C shows the FPC with only LEDs mounted thereon;

FIG. 2A is a top plan view of the thermal conductor enclosure included in the spread illuminating apparatus according to the first embodiment of the present invention, and FIGS. 2B and 2C are cross sectional views of the thermal conductor enclosure taken along line A-A of FIG. 2A and line B-B of FIG. 2A, respectively;

FIGS. 3A and 3B are cross sectional views of the FPC of FIG. 1A attached to a frame (heat radiating plate) taken along line A-A of FIG. 1A and line B-B of FIG. 1A, respectively;

FIGS. 4A and 4B are top plan views of a relevant portion of an FPC included in a spread illuminating apparatus according to a second embodiment of the present invention, wherein FIG. 4A shows the FPC with LEDs and thermal conductor enclosures mounted thereon, and FIG. 4B shows the FPC board with no components mounted thereon;

FIGS. 5A and 5B are cross sectional views of the FPC of FIG. 4A together with a heat radiating plate taken along line A-A of FIG. 4A and line B-B of FIG. 4A, respectively;

FIG. 6A is a top plan view of a thermal conductor enclosure included in a spread illuminating apparatus according to a third embodiment of the present invention, and FIGS. 6B and 6C are cross sectional views of the thermal conductor enclosure taken line A-A of FIG. 6A and line B-B of FIG. 6A, respectively;

FIGS. 7A and 7B are top plan views of a relevant portion of an FPC included in the spread illuminating apparatus according to the third embodiment of the present invention, wherein FIG. 7A shows the FPC with LEDs and thermal conductor enclosures mounted thereon, and FIG. 7B shows the FPC with no components mounted thereon;

FIG. 8 is a perspective view of a conventional spread illuminating apparatus; and

FIG. 9 is a cross sectional view of another conventional spread illuminating apparatus.

### DETAILED DESCRIPTION OF THE INVENTION

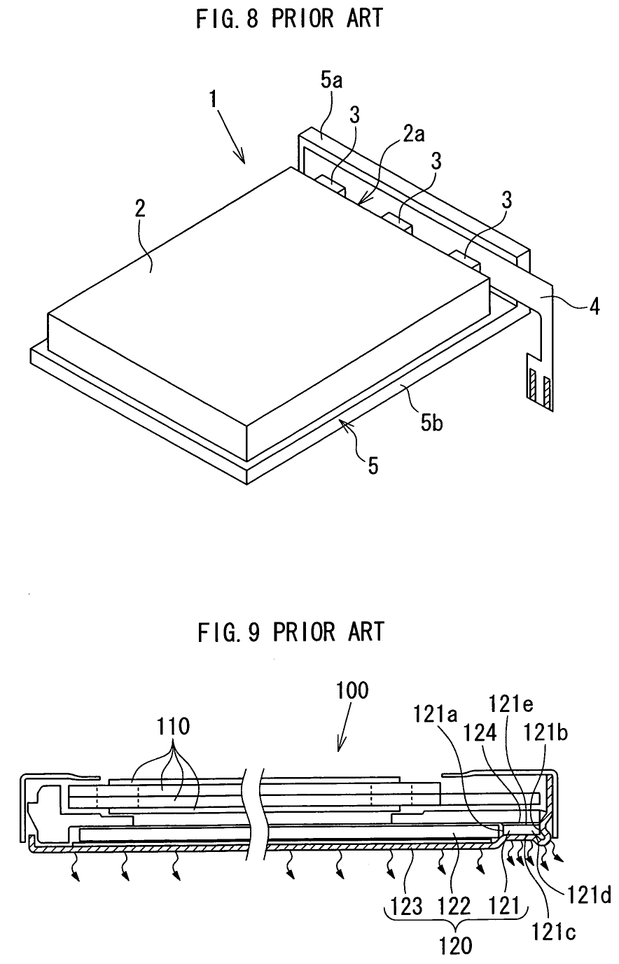

Exemplary embodiments of the present invention will hereinafter be described with reference to the accompanying drawings. It is to be noted that the drawings are for illustration and may not necessarily reflect actual configurations and dimensions correctly. Also, since the spread illuminating apparatuses according to the present invention is basically structured same as the spread illuminating apparatus 1 shown in FIG. 8, like reference numerals refer to like elements throughout the description and drawings, and redundant explanations will be omitted.

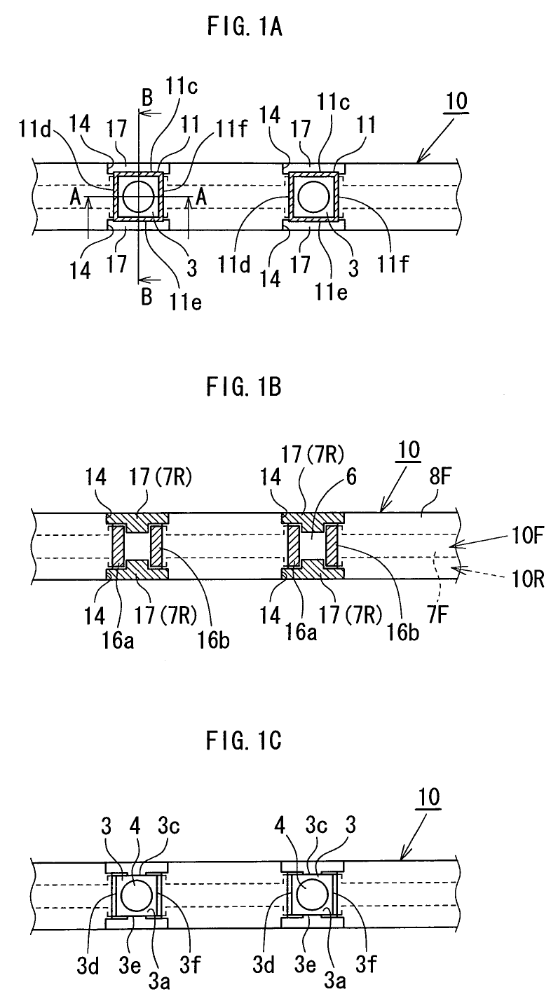

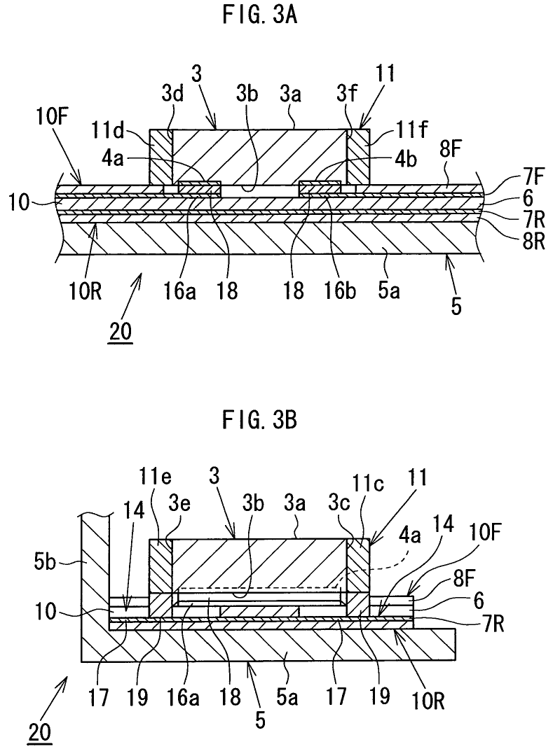

A first embodiment of the present invention will be described with reference to FIGS. 1A to 1C through FIGS. 3A and 3B. A spread illuminating apparatus according to the first embodiment includes a double-sided flexible printed circuit board (hereinafter, referred to as FPC) 10, which, as shown in FIGS. 1B, 3A and 3B, includes a base film (substrate) 6 made of polyimide or like substance, first and second conductive patterns 7F and 7R disposed on respective surfaces of the base film 6 and each formed of a copper foil patterned, and cover films 8F and 8R made of polyimide or the like and disposed so as to cover the first and second conductive patterns 7F and 7R, respectively.

A pair of electrode pads 16a and 16b on which an LED 3 as point light source is mounted are formed on the first conductive pattern 7F disposed at a front surface 10F of the FPC 10. Openings 14 and 14 are formed at prescribed portions (to be described) of the base film 6 of the FPC 10, and the second conductive pattern 7R disposed at a rear surface 10R of the FPC 10 is patterned so that the foil copper covering at least portions 17 and 17 corresponding to the openings 14 and 14 remains intact. The cover film 8F is formed so as to keep clear of at least the electrode pads 16a and 16b and the openings 14 and 14 of the base film 6 so that the portions 17 and 17 of the second conductive pattern 7R as well as the electrode pads 16a and 16b can be exposed at the front surface 10F of the FPC 10. The portions 17 and 17 constitute pads to connect a thermal conductor enclosure 11 to the second conductive pattern 7R as will be described later (the portion 17 may be referred to as thermal pad as appropriate).

Referring to FIGS. 1C, 3A and 3B, the LED 3 formed in a substantially rectangular solid which defines a light emitting face 3a with an aperture 4 for letting out emitted light, a mounting face 3b opposite to the light emitting face 3a and affixed to the FPC 10, and remaining four faces referred to as side faces 3c, 3d, 3e and 3f. A pair of electrode terminals 4a and 4b are disposed at the mounting face 3b so as to extend in parallel to and close to the side faces 3d and 3f, respectively. The electrode terminals 4a and 4b are connected respectively to the electrode pads 16a and 16b via solders 18 and 18, when the LED 3 is mounted on the FPC 10.

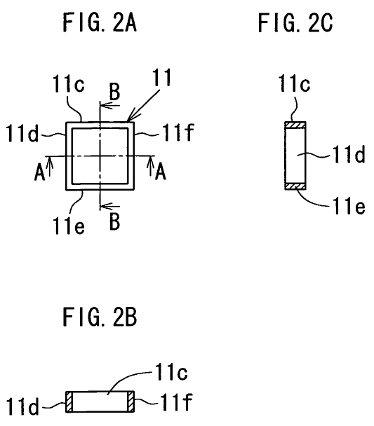

The aforementioned thermal conductor enclosure 11 is a single-piece structure as shown in FIGS. 2A, 2B and 2C, and is provided at each of a plurality (two in the figure) of LEDs 3 as shown in FIG. 1A so as to cover the side faces 3c, 3d, 3e and 3f of the LED 3. The thermal conductor enclosure 11 includes walls 11c, 11d, 11e and 11f, and is so shaped and sized as to house the LED 3, preferably such that the walls 11c, 11d, 11e and 11f make a tight contact with the side faces 3c, 3d, 3e and 3f of the LED. When the thermal conductor enclosure 11 is mounted on the FPC 10, the walls 11c and 11e are connected to the thermal pads 17 and 17 of the second conductive pattern 7R via solders 19 and 19. Thus, the thermal conductor enclosure 11 and the second conductive pattern 7R are connected to each other by thermal pathways constituted by the solders 19 and 19 immediately without the base film 6 of the FPC 10 intervening therebetween.

The thermal pads 17 and 17 of the second conductive pattern 7R, which correspond to the openings 14 and 14, are each positioned and shaped so as to cover at least part of the bottom face of the wall 11c/11e of the thermal conductor enclosure 11, preferably to cover as large an area thereof as possible for securing a sufficient solder connection while maintaining the electrode pads 16a and 16b free from interference. The thermal pad 17 as shown in FIG. 1B as an example has a rectangular configuration with a projecting area. Though not illustrated, usually, each of the solders 19 is composed of a solder layer spreading on the surface of the thermal pad 17, and an arced top portion (what is called “fillet”) continuously formed on top of the solder layer and smoothly connecting with the wall 11c/11e of the thermal conductor enclosure 11, wherein the thermal pad 17 provided with a projecting area is adapted to accommodate a proper amount of solder for duly building up the solder layer and the fillet portion. This is also preferable in terms of increasing the cross section area of the thermal pathway including the solders 19 and 19 connecting between the thermal conductor enclosure 11 and the second conductive pattern 7R to thereby lower the heat transfer resistance, which allows the heat generated at the LED 3 to be efficiently released.

The thermal conductor enclosure 11 is made of any material having a good heat conductance, and a copper material such as brass is particularly preferred because of its suitable performance conditions, such as a high thermal conductivity, an excellent workability by pressing, and a good solderability.

The FPC 10 having the LEDs 3 and the thermal conductor enclosure 11 mounted thereon as described above has its rear surface 10R attached to a wall portion 5a of a frame (heat radiating plate) 5 as shown in FIGS. 3A and 3B. In this connection, the rear surface 10R of the FPC 10 may make an immediate contact with the wall portion 5a of the heat radiating plate 5, or a thermal conductor member (not shown) may be interposed therebetween. Such a thermal conductor member may be made of a thermally conductive tape formed of a heat conducting resin composition which stays stably in a sold state at least at a room temperature, and which has a considerable stickiness or adhesiveness. The thermally conductive tape may be made, for example, by coating an acrylic resin composition to a polyethylene terephthalate (PET) film completed with peeling process. A common adhesive tape or bonding agent that provides heat radiation characteristics required may alternatively be used as such a thermal conductor member.

Thus, in the spread illuminating apparatus according to the present embodiment, heats emitted from all the side faces 3c, 3d, 3e and 3f of each LED 3 are efficiently conducted to the heat radiating plate 5, thereby improving the performance of radiating the heats generated at the LEDs 3 as point light sources. Since the heat radiation system from the thermal conductor enclosure 11 to the heat radiating plate 5 contains a thermal pathway formed such that the thermal conductor enclosure 11 and the second conductive pattern 7R are connected via the solders 19 and 19 to each other without the base film 6 of the FPC 10 intervening therebetween, the heats emitted from the LEDs 3 can be further efficiently conducted to the heat radiating plate 5 thereby achieving an effective heat radiation. Further, since the solders 19 and 19, which define a relatively small thickness and a large section area (thus rendering a low thermal resistance), connect directly between the thermal conductor enclosure 11 and the second conductive pattern 7R, the heat radiation system is advantageous in enhancing the heat radiation performance. In this connection, where possible, the second conductive pattern 7R may be partially exposed from the cover film 8R disposed at the rear surface 10R of the FPC 10, or alternatively the cover film 8R may be totally removed. In this case, since the FPC 10 is attached to the wall portion 5a of the heat radiating plate 5 with the second conductive pattern 7R communicating partly or totally with the wall portions 5a directly without the cover film 8R intervening therebetween, the heats emitted from the LEDs 3 can be further efficiently radiated.

Description will now be made on a preferred manufacturing method of an assembly structure indicated by numeral 20 in FIGS. 3A and 3B.

The first and second conductive patterns 7F and 7R are formed such that copper laminate sheets which are each composed of multiple copper foils layered on one another, and which are disposed at the respective surfaces of the base film 6 are processed by etching or like technique. The openings 14 and 14 are formed at predetermined locations of the front surface of the base film 6 by chemical etching or like technique. The cover films 8F and the cover film 8R (as required) formed into predetermined configurations are placed respectively on the first and second conductive patterns 7F and 7R by thermal compression bonding or like technique, thus completing the FPC 10 (refer to FIG. 1B).

Then, the LEDs 3 and the thermal conductor enclosures 11 are mounted on the FPC 10 by heating reflow soldering. Specifically, cream solder is applied to the electrode pads 16a and 16b for the LEDs 3 and to the thermal pads 17 and 17 for the thermal conductor enclosures 11, and the LEDs 3 and the thermal conductor enclosures 11 are mounted at predetermined places of the FPC 10. The FPC 10 with the LEDs 3 and the thermal conductor enclosures 11 duly mounted thereon is heated in a solder reflow apparatus thereby melting the cream solder applied, and then is cooled down for solidifying the melted cream solder (refer to FIG. 1A).

The rear surface 10R of the FPC 10 complete with the necessary components is affixed to the wall portion 5a of the heat radiating plate 5 thereby attaching the FPC 10 to the heat radiating plate 5 as shown in FIGS. 3A and 3B, and the assembly structure 20 is completed.

Thus, the thermal conductor enclosures 11 can be connected to the thermal pads 17 and 17 at the same time when the LEDs 3 are mounted on the FPC 10, which provides a good assembling workability. If there is a substantial air gap between the side faces 3c to 3f of the LED 3 and the thermal conductor enclosure 11 to house the LED 3, thermally conductive resin may be used to fill up the air gap. Also, the thermal conductor enclosure 11 is preferably connected to the thermal pads 17 and 17 by soldering as described above from the viewpoint of assembling workability and thermal conductance, but the present invention is not limited in connection method to soldering and the thermal conductor enclosure 11 may be connected to the thermal pads 17 and 17 by means of a thermally conductive bonding agent, or any other appropriate means.

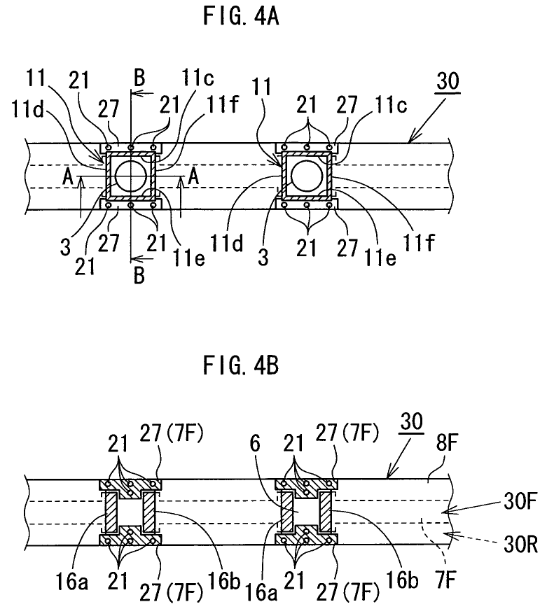

Further embodiments of the present invention will be described with reference to FIGS. 4A and 4B through FIGS. 7A and 7B. In explaining the further embodiments, any component parts corresponding to those in FIGS. 1A to 1C through FIGS. 3A and 3B are denoted by the same reference numerals, and a detailed description thereof will be omitted.

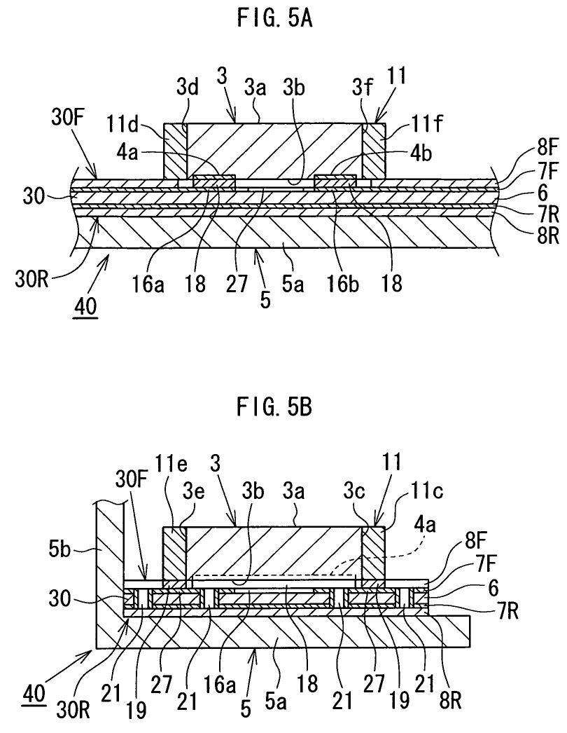

A second embodiment of the present invention will be described with reference to FIGS. 4A, 4B, 5A and 5B. A spread illuminating apparatus according to the second embodiment includes an FPC 30, which, as shown in FIGS. 4A and 4B, includes electrode pads 16a and 16b for mounting an LED 3, and also thermal pads 27 and 27 electrically insulated from the electrode pads 16a and 16b and adapted to function as a junction with a thermal conductor enclosure 11, both the electrode pads 16a and 16b and the thermal pads 27 and 27 being formed at a first conductive pattern 7F disposed at a front surface 30F of the FPC 30. Each of the thermal pads 27 and 27 is provided with a plated coat and preferably includes a plurality (three in the figure) of throughholes 21 communicating with a second conductive pattern 7R disposed at a rear surface 30R of the FPC 30. In the present embodiment, the throughholes 21 function as a thermal pathway to connect between the thermal conductor enclosure 11 and the second conductive pattern 7R directly without a base film 6 of the FPC 30 intervening therebetween. The thermal pads 27 and 27 are located and shaped in a similar manner to the thermal pads 17 and 17 of the first embodiment described above, and a cover film 8F is formed so as to expose at least the electrode pads 16a and 16b and the thermal pads 27 and 27.

In the spread illuminating apparatus according to the second embodiment described above, heat generated at each of the LEDs 3 and emitted from side faces 3c, 3d, 3e and 3f of the LED 3 is caused to be conducted to a heat radiating plate 5, thereby improving the performance of radiating heats generated at point light sources. Since the heat radiation system from the thermal conductor enclosure 11 to the heat radiating plate 5 contains a thermal pathway formed such that the thermal conductor enclosure 11 and the second conductive pattern 7R are connected via the throughholes 21 to each other without a base film 6 of the FPC 30 intervening therebetween, the heats emitted from the LEDs 3 can be efficiently conducted to the heat radiating plate 5 thereby achieving an effective heat radiation.

An assembly structure indicated by numeral 40 in FIGS. 5A and 5B is preferably manufactured in the same way as the assembly structure indicated by numeral 20 (refer to FIGS. 3A and 3B) explained in the description of the first embodiment, except for the FPC producing process where the FPC 30 is formed to include the thermal pads 27 and 27 having the throughholes 21 (refer to FIG. 4B), and the same advantages are available. In addition, since the thermal pads 27 and 27 for communication with the thermal conductor enclosure 11 and the electrode pads 16a and 16b for mounting the LED 3 reside in the same plane, the process of mounting the thermal conductor enclosure 11 onto the FPC 30, especially the process of applying cream solder to the thermal pads 27 and 27, can be performed easily. Also, like the first embodiment, each solder 19 shown in FIG. 5B is ordinarily composed of a solder layer spreading on the surface of the thermal pad 27, and a fillet portion continuously formed on top of the solder layer and smoothly connecting with a wall 11c/11e of the thermal conductor enclosure 11, wherein a proper amount of solder is accommodated at the thermal pad 27 so as to duly build up the solder layer and the fillet portion. Further, in the FPC 30 according to the second embodiment, cream solder applied to the thermal pad 27 may be caused to flow into the throughholes 21 when melted by heating, thereby filling in the throughholes 21 partly or totally, which enhances the heat conductance of the thermal pathway in the present embodiment. The throughholes 21 are shaped circular as shown in FIGS. 4A and 4B in view of workability, but the present invention is not limited to the circular configuration. Also, the present invention is not limited in number and position of the throughholes 21 to the particular arrangement shown in FIGS. 4A, 4B, 5A and 5B, and the throughholes 21 may be arranged with an appropriate number and position in consideration of various conditions at the process of mounting the LEDs 3.

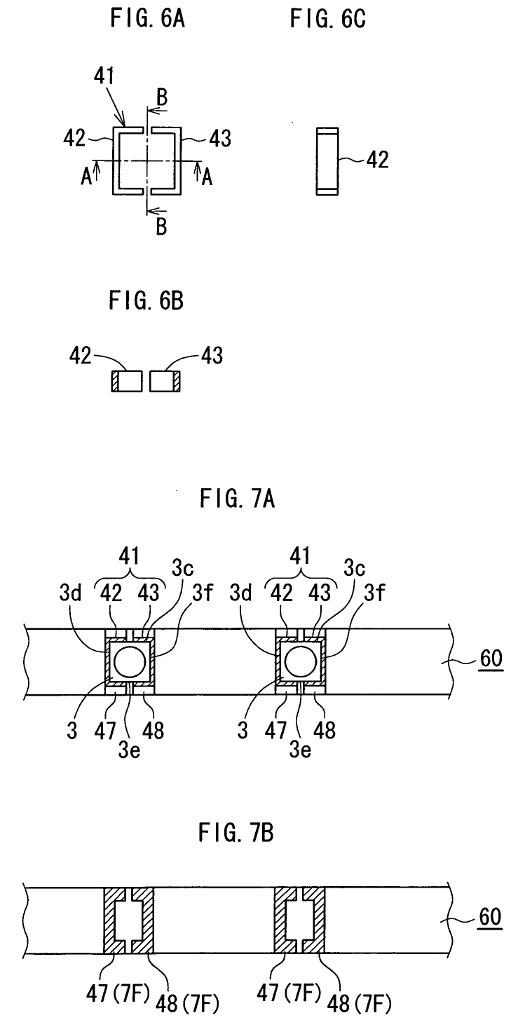

A third embodiment of the present invention will be described with reference to FIGS. 6A to 6C and FIGS. 7A and 7B. A spread illuminating apparatus according the third embodiment includes an FPC 60 (refer to FIGS. 7A and 7B) including a thermal conductor enclosure 41, which is composed of a pair of “squared-C shaped” members 42 and 43 as shown in FIG. 6A. The thermal conductor enclosure 41 is mounted on the FPC 60 such that one squared-C shaped member 42 is disposed at a side face 3d of an LED 3 toward an electrode terminal 4a (refer, for example, to FIG. 3A) while the other squared-C shaped member 43 is disposed at a side face 3f of the LED 3 toward an electrode terminal 4b (refer, for example, to FIG. 3A) as shown in FIG. 7A, whereby the LED 3 has its all side faces 3a to 3f covered by the thermal conductor enclosure 41.

The FPC 60 according to the present embodiment includes pads 47 and 48 formed at a first conductive pattern 7F as shown in FIG. 7B. The pad 47 integrally includes an electrode portion for electrical connection with the electrode terminal 4a of the LED 3 and a thermal conduction portion for thermal connection with the squared-C shaped member 42, and the pad 48 integrally includes an electrode portion for electrical connection with the electrode terminal 4b of the LED 3 and a thermal conduction portion for thermal connection with the squared-C shaped member 43. The LED 3 and the thermal conductor enclosure 41 are mounted on the FPC 60 such that the electrode terminal 4a and the squared-C shaped member 42 are connected to the pad 47 while the electrode terminal 4b and the squared-C shaped member 43 are connected to the pad 48.

Thus, in the spread illuminating apparatus according to the present embodiment, heats emitted from all the side faces 3c to 3f of the LED 3 can be duly conducted to a heat radiating plate 5, thereby improving the performance of radiating the heats emitted from the LED 3. Also, the thermal conductor enclosure 41, which is composed of two separate constituent members 42 and 43, can be readily brought into a closer and tighter contact with the side faces 3c to 3f of the LED 3 when mounted on the FPC 60. Specifically, for example, the squared-C shaped member 42 can be easily set to the side face 3d of the LED 3 with a firm contact ensured therebetween, and the squared-C shaped member 43 can be easily set to the side face 3f of the LED 3 with a firm contact ensured therebetween. This contributes to enhancing the heat conducting performance from the LED 3 to the thermal conductor enclosure 41.

Since the two constituent members 42 and 43 are disposed with an air gap formed therebetween thus ensuring electrical insulation from each other, each of the pads 47 and 48 can be structured into one single piece integrally including an electrode portion for connection with the LED 3 and a thermal conduction portion for connection with the thermal conductor enclosure 41, thus simplifying the structure of the FPC 60 and consequently reducing the wiring space.

Though not illustrated, the pads 47 and 48 are preferably provided with throughholes communicating with a second conductive pattern 7R, which produces the advantages same as or similar to those of the second embodiment described above.

The two separate constituent members of a thermal conductor enclosure according to the present embodiment are not limited in shape to the squared-C as described above, but may alternatively be shaped, for example, in “L” letter such that one L shaped member covers two adjacent side faces (for example, sides 3d and 3e) of the LED 3 while the other L shaped member covers the remaining two adjacent side face (for example, side faces 3c and 3f). The thermal conductor enclosure thus structured can be easily mounted on the FPC ensuring a firm contact with all the side faces 3c to 3f of the LED 3.

The pads 47 and 48 in the third embodiment are each structured into one single piece including integrally the thermal portion to connect with the squared-C members 42 and 43 and the electrode portion to connect with the electrode terminals 4a and 4b, respectively, but the present invention is not limited to application together with such an integral pad structure, and a thermal conductor enclosure composed of two separate constituent members may be employed in combination with a separate pad structure as described with respect to the first or second embodiment, where the FPC includes the electrode pad 16a/16b and the thermal pad 17/17 (or 27/27) formed separate from the pad 16a/16b.

While the present invention has been illustrated and explained with respect to specific embodiments thereof, it is to be understood that the present invention is by no means limited thereto but encompasses all changes and modifications that will become possible within the inventive concepts.

For example, the thermal conductor enclosure is not limited in shape to those indicated by reference numerals 11 and 41 but may be optimally shaped according to the configuration of the LED 3, the structure of the electrodes 4a and 4b, the mounting mode of the LED 3 on the FPC 10, and the like. In this regard, copper material such as brass, which can be relatively flexibly processed into a desired shape by pressing, is suitable.

Also, the thickness of a wall (for example, the wall 11e in FIG. 3B) of the thermal conductor enclosure may be adjusted so as to make contact with the floor portion 5b of the heat radiating plate 5 thereby forming an auxiliary thermal pathway. The spread illuminating apparatus according to the present invention allows such a contact easily without deforming the heat radiating plate 5.

And, in the spread illuminating apparatus according to the present invention, throughholes may be appropriately provided which communicate between the first conductive pattern 7F and the second conductive pattern 7R, so that heats conducted from the electrode terminals 4a and 4b to the first conductive pattern 7F can be efficiently conducted to the heat radiating plate 5.

What is claimed is:

1. A spread illuminating apparatus comprising:
a light conductor plate;
at least one point light source disposed at a side surface of the light conductor plate;
a flexible printed circuit board comprising a conductive pattern and having the at least one point light source mounted thereon;
a heat radiating plate to hold the flexible printed circuit board; and
at least one thermal conductor enclosure which each covers side faces of each point light source, and which is connected to the conductive pattern of the flexible printed circuit board.

2. A spread illuminating apparatus according to claim 1, wherein: the flexible printed circuit board further comprises a substrate, with the conductive pattern being composed of first and second conductive patterns formed respectively at a front surface and a rear surface of the substrate; the point light source is mounted on a pair of electrode pads formed at the first conductive pattern; the flexible printed circuit board has its rear surface affixed to the heat radiating plate; and a heat radiation system from the thermal conductor enclosure to the heat radiating plate contains a thermal pathway which connects between the thermal conductor enclosure and the second conductive pattern without the substrate intervening therebetween.

3. A spread illuminating apparatus according to claim 2, wherein the flexible printed circuit board comprises an opening at a front surface thereof so as to expose a part of the second conductive pattern, and the thermal pathway is formed such that the thermal conductor enclosure is connected to the part of the second conductive pattern exposed from the opening.

4. A spread illuminating apparatus according to claim 2, wherein the thermal conductor enclosure is connected to a thermal pad formed at the first conductive pattern, and the thermal pathway is formed such that a throughhole communicating with the second conductive pattern is formed at the thermal pad.

5. A spread illuminating apparatus according to claim 1, wherein the thermal conductor enclosure comprises two separate members opposing each other with an air gap therebetween.

6. A spread illuminating apparatus according to claim 5, wherein the two separate members of the thermal conductor enclosure are connected respectively to the pair of electrode pads having each point light source mounted thereon.

7. A spread illuminating apparatus according to claim 1, wherein the thermal conductor enclosure is made of a copper material and connected to the conductive patter by soldering.

8. A spread illuminating apparatus according to claim 7, wherein the thermal conductor enclosure is connected to the conductive pattern when the point light source is mounted on the flexible printed circuit board.
